(19) United States
(12) Patent Application Publication
(10) Pub. No.: US 2010/0112406 A1
(43) Pub. Date: May 6, 2010

(54) ULTRASONICALLY ENHANCED FUEL CELL SYSTEMS AND METHODS OF USE

(75) Inventors: Hongtan Liu, Miami, FL (US); Jiahua Han, Grayslake, IL (US); Jiabin Ge, South Pasadena, CA (US)

Correspondence Address: NIXON & VANDERHYE, PC, 901 NORTH GLEBE ROAD, 11TH FLOOR, ARLINGTON, VA, 22203, US

(73) Assignee: THE UNIVERSITY OF MIAMI, Miami, FL (US)

(21) Appl. No.: 12/305,288

(22) PCT Filed: Jun. 21, 2007
(86) PCT No.: PCT/US07/14502

§ 371 Date: Dec. 23, 2009

Related U.S. Application Data
(60) Provisional application No. 60/815,268, filed on Jun. 21, 2006.

(51) Int. Cl. H01M 8/10; H01M 8/00; H01M 2/00

(52) U.S. Cl. 429/30; 429/12; 429/34

(57) ABSTRACT

A fuel cell system comprises at least one fuel source (e.g., methanol or methanol solution) In a storage tank, tubes and/or flow channels that provide the fuel to the fuel cells via tubes and/or flow channels, which are used to connect the different fuel cells and/or supply the fuel to all or some of the fuel cells, one or more ultrasonic transducers, which are set inside or are associated with the tubes and/or flow channels through which the fuel (e.g., methanol or methanol solution) is supplied to the fuel cells. The transducers can optionally be integrated with the tubes and/or flow channels of the fuel cell systems. The ultrasonic transducers are able to generate high frequency vibration, and the fuel is able to transmit the high-frequency vibration through the liquid fuel body, to increase the performance of the fuel fed fuel cell system.

### RELATED APPLICATION

This application claims priority from and is based upon U.S. Provisional Patent Application Ser. No. 60/815,268, filed on Jun. 21, 2006, the entire content of which is hereby incorporated by reference.

### FIELD AND BACKGROUND OF THE INVENTION

The present invention involves ultrasonically enhanced fuel cell systems and their methods of use. Direct methanol fuel cells (DMFC), alkaline electrolyte fuel cells (AFCs), and other fuel cells are promising substitutes for petrol-oil energy sources. However, due to the methanol crossover and less activity of methanol reaction at the cell anode of DMFCs, the poor performance of DMFCs has been a large obstacle to DMFC commercialization. Similar problems exist with other fuel cells.

In the present invention, an ultrasonic transducer is introduced to improve the performance of a DMFC, AFC, and other fuel cells. The test results of the invention demonstrate that ultrasonic vibration inside the methanol fuel surprisingly improves the cell performance by about 13-25% under different cell operating voltages. Similar performance gains can be achieved for other fuel cells.

### BRIEF DESCRIPTION OF THE DRAWINGS

FIG. 1 is an embodiment of the invention and for testing the effect of ultrasonic vibration on the performance of a DMFC.

FIG. 2 is an embodiment of the invention comprising at least one ultrasonic transducer in a liquid fuel fed fuel cell system.

FIG. 3 is an embodiment of the invention comprising at least one ultrasonic transducer in a LEFC system.

### SUMMARY AND DETAILED DESCRIPTION OF THE INVENTION

DMFC technology, along with hydrogen polymer electrolyte membrane (PEM) fuel cell technology, are promising substitutes for petrol-oil based energy sources. Compared with the fuel for a hydrogen PEM fuel cell, the net energy density of methanol is higher than both 300 bar hydrogen gas in composite cylinders, hydrogen gas in metal hydride cylinders, and hydrogen from methanol. Methanol is also easy to store.

Nevertheless, there are also two very pressing problems for the commercialization of direct methanol fuel cells. The first one is the lower activity of methanol reaction at the anode catalyst layer. The second one is the methanol crossover. Methanol can be dissolved into water to any degree, while the electrolyte polymer very easily absorbs water and methanol. Methanol fuel at the anode very quickly reaches the cathode, which shows itself as a reduced open circuit voltage but effects the performance of the fuel cell at all currents.

Ultrasonic engineering concerns the use of high-frequency mechanical vibrations to improve a product or a process. In general, the term ultrasonic refers to those sounds which are too high in frequency to be heard by the human ear. One application of this kind of vibration is to produce cavitations in a liquid. The cavitations have an effect on the chemical reactions by the appearance of equal and opposite free charges at opposite ends of the bubbles, the enormous local increase of pressure and temperature when the bubbles collapse, and the release of energy from the bubbles when resonating with the ultrasonic waves. It has been discovered that this technique is beneficial in the setting of DMFC technology.

More specifically, an ultrasonic transducer is introduced to improve the performance of a direct methanol fuel cell. It has been discovered that the possible mechanism of how the high-frequency vibration effects the performance of a fuel cell lies in four processes:

1) effecting the chemical reaction on the electrodes and lowering of the activation losses;

2) effecting the diffusivity of methanol and lowering of the mass transport losses;

3) effecting the conductivity of protons inside the polymer electrolyte, and lowering of the ohmic losses;

4) effecting the removal of the carbon dioxide bubbles produced at the anode side electrode.

### Experiments/Examples

The fuel cell test station utilized in these experiments was manufactured by Fuel Cell Technology, Inc. A major component of the test station is the HP® 6050A system DC electronic load controller, which is capable of controlling the electrical load on the fuel cell as well as measuring its voltage versus current responses. This experimental system also provides control over anode and cathode flow rates, cell operating temperature, operating pressure, and humidification temperature for the cathode. The cathode mass flow rate is controlled and measured by a MKS® mass flow controller, and the anode flow rate is controlled and measured by a peristaltic pump by Gilson, Inc. An ultrasonic transducer is set inside the tube between the pump and the cell to generate the high-frequency vibration, and the vibration is transmitted inside the methanol solution.

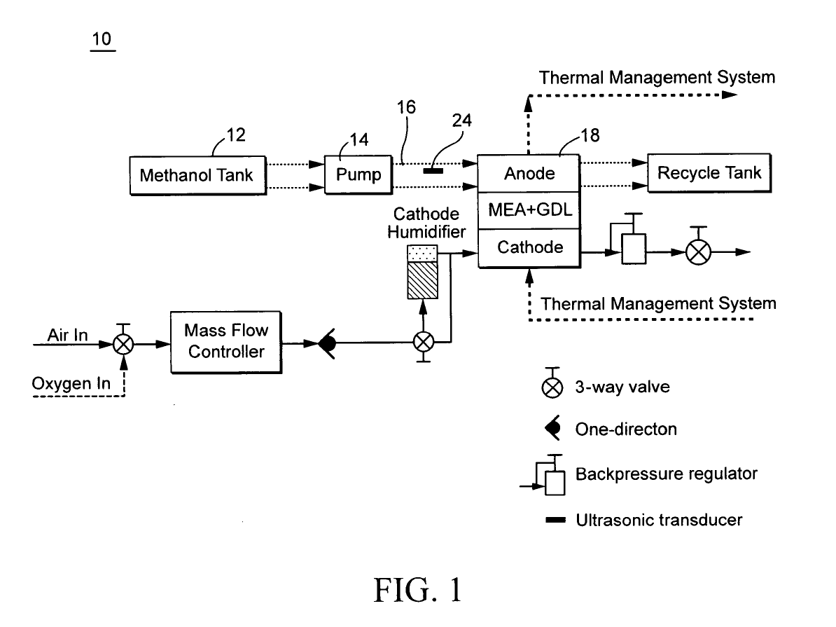

An embodiment as shown in FIG. 1 was used to carry out the tests, and is an embodiment or experimental scheme for testing the effect of ultrasonic vibration on the performance of a DMFC. The system of FIG. 1 comprises a methanol tank 12 that supplies methanol in the system 10, a pump 14 that pumps the methanol through tubes and/or flow channels 16, which are used to connect the different fuel cells and/or supply the methanol/methanol solution to all or some of the fuel cells 18, one or more ultrasonic transducers 24, which are set inside the tubes and/or flow channels 16 through which the fuel (e.g., methanol or methanol solution) is supplied to the fuel cells 18. The transducers can optionally be integrated with the tube and/or flow channels of the fuel cell systems. The ultrasonic transducers are able to generate high frequency vibration, and the fuel is able to transmit the high-frequency vibration through the liquid fuel body, to increase the performance of the fuel fed fuel cell system. The ultrasonic transducers may optionally be set inside one or more containers which are connected to the tubes and/or flow channels.

The experimental fuel cell consisted of two 316 stainless steel end plates, two graphite collector plates with machined serpentine flow fields, two diffusion layers, two catalyst layers, and the electrolyte membrane. The cell was kept at a constant temperature through the thermal management system during each experiment. The electrolyte membrane used was Nafion® 117, the gas diffusion layers on the anode side were carbon cloth and ETEK ELAT® on the cathode side, the catalyst was Pt—Ru on the anode side with a loading of 4 mg cm⁻², and Pt-black on the cathode side with a loading of 4 mg cm⁻². The whole cell active area was 5 cm².

### Results

Both polarization and time test experiments were carried out to test the effect of high-frequency vibration on the cell performance. The cell operating conditions were as follows: the methanol concentration was 2M and the feeding flow rate was 3 ml/min, the cathode reactant was oxygen and the feeding flow rate was 800 sccm, the cell temperature range was 70° C., and the time test experimental results are shown in Graphs 2 and 3. In Graph 2, the cell operating voltage was 0.1V. In Graph 3, the cell operating voltage was 0.3V. The cell polarization curves are shown in Graph 4, and the corresponding experimental data are shown in Table 1.

TABLE 1
Experimental data for the cell polarization curves as shown in Graph 4.

| | |
|---|---|
| Without Ultrasonic | With Ultrasonic |

| I (A/cm\hat{ }2) | V (V) | I (A/cm\hat{ }2) | V (V) |
|---|---|---|---|
| 0.002 | 0.658 | 0.002 | 0.692 |
| 0.01 | 0.609 | 0.01 | 0.609 |
| 0.09 | 0.51 | 0.11 | 0.51 |
| 0.302 | 0.394 | 0.376 | 0.394 |
| 0.528 | 0.294 | 0.648 | 0.294 |
| 0.842 | 0.212 | 0.956 | 0.195 |
| 1.094 | 0.096 | 1.242 | 0.096 |

From Graph 4 and Table 1, it can seen that the cell performance was improved by 22.22%, 24.50%, 22.72% and 13.52%, respectively, when the cell was operating with 0.509V, 0.394V, 0.294V and 0.096V. Thus, in the present invention, the ultrasonic transducer that generated high-frequency vibration has a significant, beneficial effect on the cell performance of a DMFC. When the cell operating voltage was between 0.1V and 0.5V, the experimental results demonstrated that the cell performance was improved by about 13-25%, which is quite significant for the commercialization of DMFCs.

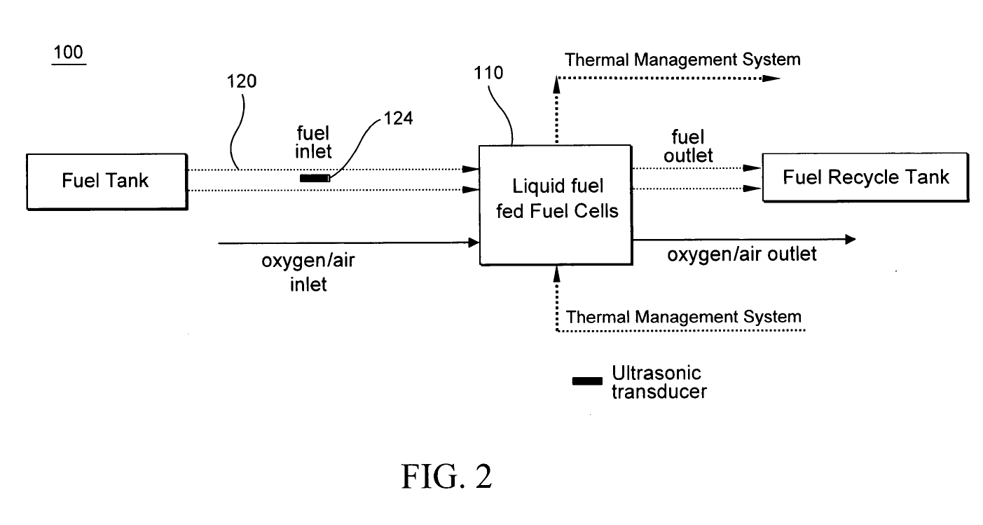

The present invention can employ many different designs. In one non-limiting embodiment of the invention, the system can comprise the elements identified in FIG. 2.

In FIG. 2, which is an embodiment of the present invention, an ultrasonically enhanced liquid fuel fed fuel cell system 100 comprises:

a. One or more liquid fuel fed fuel cells 110, where the liquid fuel is used as the fuel to generate electricity by transferring the chemical energy of the liquid fuel directly into electrical energy. The liquid fuel fed fuel cell system also includes other commonly known elements to supply the liquid fuel to the liquid fuel fed fuel cells continuously by passive or active methods or a combination of both kinds of methods. The liquid fuel can include all kinds of fuel that can be used for a fuel cell, under normal or working conditions, in a liquid state, including, but not limited to methanol, methanol solutions, ethanol, ethanol solutions, and mixtures thereof.

b. Tubes and/or flow channels 120, which are used to connect the different fuel cells and/or supply the liquid fuel to all or some of the liquid fuel fed fuel cells 110.

c. One or more ultrasonic transducers 124, which are set inside the tubes and/or flow channels 120 through which the liquid fuel is supplied to the liquid fuel fed fuel cells. The transducers can optionally be integrated with the tube and/or flow channels of the liquid fuel fed fuel cell systems. The ultrasonic transducers are able to generate high frequency vibration, and the liquid fuel is able to transmit the high-frequency vibration through the liquid fuel body, to increase the performance of the liquid fuel fed fuel cell system. The ultrasonic transducers may optionally be set inside one or more containers which are connected to the tubes and/or flow channels.

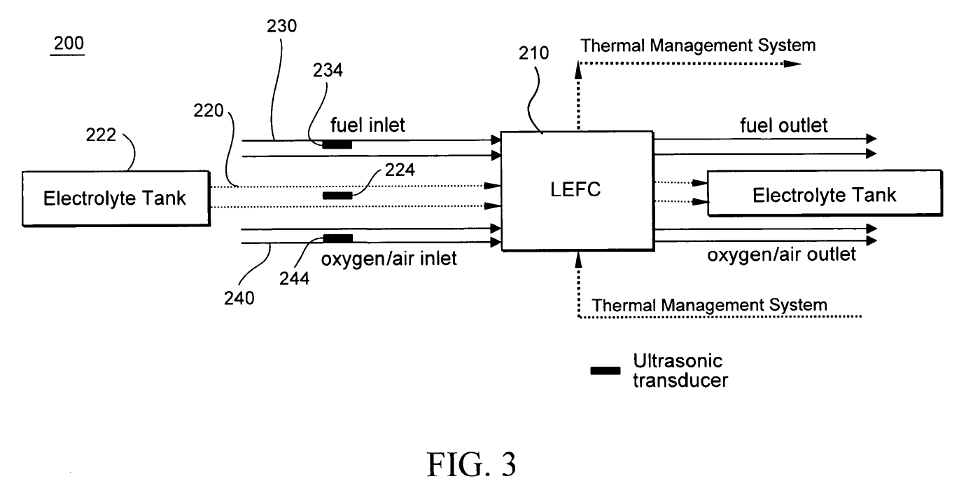

In another non-limiting embodiment of the invention, the system can comprise the elements identified in FIG. 3, which is an ultrasonically enhanced liquid electrolyte fuel cell (LEFC) system 200, including:

a. One or more liquid electrolyte fuel cells 210 and, optionally, other elements, each of the cells comprising at least one cathode and at least one anode where electrochemical reactions occur, and an electrolyte where ions are able to transfer inside at the fuel cells working conditions. The liquid electrolyte fuel cell includes a phosphoric acid fuel cell, molten carbonate fuel cell, alkaline electrolyte fuel cell or any other kind of fuel cells where high frequency vibration is able to transmit inside the electrolyte under working conditions.

b. Electrolyte supply tubes/channels 220, which are used to supply and/or distribute the electrolyte from an electrolyte tank 222 to or inside each LEFC or connect the electrolyte between different LEFCs.

c. Fuel supply tubes/channels 230, which are used to supply fuel to one of the electrodes of each LEFC.

d. Oxygen/air supply tubes/channels 240, which are used to supply oxygen/air to another of the electrodes of each LEFC.

e. One or more ultrasonic transducers 224 set inside the electrolyte supply tubes/channels through which the electrolyte is supplied to or distributed inside the LEFC system. Ultrasonic transducers 234 and 244, respectively, are optionally set inside the fuel and/or oxygen/air supply tubes/channels through which the fuel and/or oxygen/air is supplied to the LEFC system. The transducers are optionally integrated with the electrolyte supply tubes/channels and/or the fuel supply tubes/channels and/or the oxygen/air supply tubes/channels and/or the LEFC system. The ultrasonic transducers are able to generate high frequency vibration with or without the interference of the electrolyte and/or the fuel and/or oxygen/air. The electrolyte/fuel/air/oxygen are able to transmit high frequency vibration through the electrolyte/fuel/air/oxygen, with the result of improving the performance of the LEFC system. The ultrasonic transducers (224, 234 and 244, respectively) are optionally set inside one or more containers that are connected to the electrolyte supply tubes/channels and/or the fuel supply tubes/channels and/or the oxygen/air supply tubes/channels.

f. Optionally, the ultrasonic transducer can be set in the gas feeding channel for other fuel cells like hydrogen proton exchange membrane fuel cells, solid oxide fuel cells, molten carbon fuel cells, etc., and, optionally, can be integrated with the fuel/air/oxygen supply tubes or flow channels or the fuel cell stack.

The various aspects of the present invention have applicability in the fields of methanol, ethanol, methanol/ethanol, and other liquid fuel based energy systems including DMFC portable power generations, DMFC stationary power generations, DMFC clean energy vehicles, DMFC notebook batteries, DMFC batteries for military use and for PDAs, cell-phones, etc., and ethanol based energy systems like direct ethanol fuel cells (DEFCs), portable and stationary power generation, etc., and other ethanol based energy systems like the DMFC systems mentioned above. They also have applicability in the fields of alkaline electrolyte fuel cells (AFCs), AFC portable power generation, AFC stationary power generation, AFC vehicles, phosphoric acid fuel cells (PAFCs), PAFC portable power generation, PAFC stationary power generation, PAFC vehicles, molten carbonate fuel cells (MCFCs), MCFC portable power generation, MCFC stationary power generation, MCFC vehicles, etc.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the specification and claims.

What is claimed is:

1. A fuel cell system comprising at least one ultrasonic transducer.

2. A fuel cell system according to claim 1, wherein the ultrasonic transducer is located in tubes and/or flow channels.

3. A fuel cell system according to claim 1, wherein the tubes and/or flow channels are used to supply fuel to fuel cells.

4. A fuel cell system according to claim 1, wherein the tubes and/or flow channels are used to connect different fuel cells in the system.

5. A fuel cell system according to claim 1, wherein the system comprises a liquid fuel fed fuel cell system.

6. A fuel cell system according to claim 1, wherein the system comprises one or more liquid fuel fed fuel cells.

7. A fuel cell system according to claim 5, wherein liquid fuel is used as fuel to generate electricity by transferring chemical energy of said liquid fuel directly into electrical energy, and said liquid fuel fed fuel cell system also includes other elements to supply said liquid fuel to said liquid fuel fed fuel cells continuously by passive or active methods or a combination of both kinds of methods, and said liquid fuel comprises methanol, methanol solutions, ethanol, ethanol solutions, or mixtures thereof.

8. A fuel cell system according to claim 2, comprising one or more ultrasonic transducers, wherein said ultrasonic transducers are set inside said tubes and/or flow channels through which said liquid fuel is supplied to fuel cells, and said transducers can optionally be integrated with said tube and/or flow channels or said liquid fuel fed fuel cell systems.

9. A fuel cell system according to claim 8, wherein said ultrasonic transducers are able to generate high frequency vibration, said liquid fuel is able to transmit said high-frequency vibration through said liquid fuel, to increase the performance of said fuel cell system.

10. A fuel cell system according to claim 9, wherein said ultrasonic transducers may optionally be set inside one or more containers which are connected to said tubes and/or flow channels.

11. A method of generating energy and/or electricity by using a fuel cell system comprising at least one ultrasonic transducer.

12. A liquid electrolyte fuel cell (LEFC) system comprising at least one ultrasonic transducer.

13. A liquid electrolyte fuel cell (LEFC) system according to claim 12, comprising electrolyte supply tubes and/or channels, wherein said electrolyte supply tubes and/or channels are used to supply and/or distribute electrolyte to or inside at least one liquid electrolyte fuel cell or supply electrolyte between different liquid electrolyte fuel cells.

14. A liquid electrolyte fuel cell (LEFC) system according to claim 12, comprising at least one fuel cell with electrodes, and fuel supply tubes and/or channels, wherein said fuel supply tubes and/or channels are used to supply fuel to one of the electrodes of each fuel cell.

15. A liquid electrolyte fuel cell (LEFC) system according to claim 14, comprising oxygen and/or air supply tubes and/or channels, wherein said oxygen and/or air supply tubes and/or channels are used to supply oxygen and/or air to another of the electrodes of each fuel cell.

16. A liquid electrolyte fuel cell (LEFC) system according to claim 13, comprising one or more ultrasonic transducers, wherein said ultrasonic transducers are set inside said electrolyte supply tubes and/or channels through which said electrolyte is supplied to or distributed inside said LEFC system, said ultrasonic transducers are optionally set inside fuel and/or oxygen and/or air supply tubes and/or channels through which fuel and/or oxygen and/or air is supplied to said LEFC system, and said transducers are optionally integrated with said electrolyte supply tubes and/or channels and/or said fuel supply tubes and/or channels and/or said oxygen and/or air supply tubes and/or channels and/or said LEFC system.

17. A liquid electrolyte fuel cell (LEFC) system according to claim 16, wherein said ultrasonic transducers are able to generate high frequency vibration with or without the interference of said electrolyte and/or said fuel and/or oxygen and/or air, and said electrolyte, fuel, oxygen and/or air are able to transmit said high frequency vibration through said electrolyte, fuel, oxygen and/or air, with the result of improving the performance of said LEFC system.

18. A liquid electrolyte fuel cell (LEFC) system according to claim 17, wherein said ultrasonic transducers are optionally set inside one or more containers that are connected to said electrolyte supply tubes and/or channels and/or said fuel supply tubes and/or channels and/or said oxygen and/or air supply tubes and/or channels.

19. A fuel cell system comprising at least one ultrasonic transducer set in a gas feeding tube and/or channel to a fuel cell or between at least two fuel cells.

20. A fuel cell system according to claim 19, wherein each fuel cell is a hydrogen proton exchange membrane fuel cell, solid oxide fuel cell, molten carbon fuel cell, or other type of fuel cell.

21. A fuel cell system according to claim 19, comprising fuel, air and/or oxygen supply tubes or flow channels or a fuel cell stack.

22. A fuel cell system according to claim 21, wherein said supply tubes or flow channels contain at least one ultrasonic transducer.
